(19) United States
(12) Patent Application Publication
(10) Pub. No.: US 2021/0406999 A1
(43) Pub. Date: Dec. 30, 2021

(54) Peer to Peer Information Maintenance and Processing Device and Method of Use

(71) Applicants: Independence Jorji, Irving, TX (US); Gary Holmes, Grapevine, TX (US)

(72) Inventors: Independence Jorji, Irving, TX (US); Gary Holmes, Grapevine, TX (US)

(73) Assignee: Lyndrx, LLC, Irving, TX (US)

(21) Appl. No.: 16/916,400

(22) Filed: Jun. 30, 2020

(51) Int. Cl. G06Q 40/02; H04L 29/06

(52) U.S. Cl. CPC G06Q 40/025; H04L 63/0853

(57) ABSTRACT

A computer system for processing user data with a network, network interface, system bus, RAM, processing system and a user device.

### CROSS-REFERENCE TO RELATED APPLICATIONS

Not applicable.

### STATEMENT REGARDING FEDERALLY SPONSORED RESEARCH

Not applicable.

### BACKGROUND

When the average American is in a short sided financial set back and in need for a rapid funding they look for loan companies (such as quick loan, cash advance USA, etc.) to give them a small minor loan to make ends meet until they get back on the right track.

The problem with some large economic entities is that the loaners require extensive background information and take a process of forty hours to review and possibly decline a request. In some cases, if the loaner is requesting a 15% or higher interest rate in their initial investment, customers are being driven away because they can't afford the high return. Many loaner companies are in-person-based and some are computer based, but lacking flexibility for the current age of technology as well as young new customers.

In several embodiments, the present invention generally relates to improved systems and devices for processing, assessing, and generating loan and lender information as well as methods of using the same.

The present invention is distinguished over the following prior art.

U.S. Pat. No. 8,024,762 discloses providing virtual content over a network. The present invention is distinguished from '762 because it does not do point-to-point. The patent listed above differs from the present invention in that it is a solution for delivering digital content to consumers as well as providing digital ownership of said content, in an attempt to obviate the need for physical media. This is not a solution to consumer lending such as the present invention.

U.S. Pat. No. 8,144,619 discloses multifactorial optimization. The patent listed differs from our product in that it determines risk factor and attempts to match bidders with sellers based on this risk factor. Our product does not attempt to match sellers with bidders, it is an open market for users to request loans.

U.S. Pat. No. 8,271,802 discloses a secure data parser method and system. The product in the patent listed is a solution for securely storing data in multiple portions, not a solution for a consumer lending platform such as our product.

U.S. Pat. No. 8,874,480 discloses a centralized payment method and system for online and offline transactions. The product in the patent listed is a solution for transaction services, not a solution for a consumer lending platform such as our product.

U.S. Pat. No. 9,177,313 discloses a system and method for issuing trading financial instruments with smart features. The product explained in the patent listed is a hardware solution for storing data in financial instruments, not a solution for a peer to peer lending platform such as our product.

U.S. Pat. No. 9,589,266 discloses a restricted-use account payment administration apparatus. The product in the patent listed attempts to allow users to pay for services such as buying a pharmaceutical drug from a pharmacy, scan the receipt and receive reimbursement from a restricted use account; in the case of a pharmaceutical drug, the reimbursement would come from an insurance agency.

U.S. Pat. No. 9,760,871 discloses an event-triggered business-to-business electronic payment processing apparatus and method of use. The patent describes a product that attempts to make business to business transactions more convenient for the end user, not facilitate loans between two individual parties as the present invention does.

U.S. Pat. No. 9,818,092 discloses a system and method for executing financial transactions. The product in the patent listed relies heavily on a blockchain to verify and complete cryptocurrency transactions between users, where ours does not.

U.S. Pat. No. 10,541,821 discloses systems and methods for storing and sharing transactional data using distributed computing systems. The product in the patent listed differs from ours in that it relies on blockchain technology to store and verify transactions between identifiers.

U.S. Pat. No. 10,565,645 discloses systems and methods for operating math-based currency exchange. The listed patent describes a product that attempts to merge several credit requests with several deposit requests in order to find the most optimal trade sequence. The present invention allows users to lend directly from each other.

US patent application 2015/0206106 discloses a method for creating, issuing and redeeming pay assured contracts. The present invention is distinguished from '106 because it is a lending platform designed to facilitate peer to peer lending to family and friends and people around the world, turning peer to peer lending into an investment opportunity with a guarantee on return.

US patent application 2017/0046689 discloses a crypto voting and data structure apparatus and method of use. The product in the patent listed differs from ours in that it relies on storing information on a user in a blockchain, to verify and monitor transactions and contracts via nodes running on the blockchain.

US patent application 2017/0048209 discloses a crypto key recovery and data structure method and system. The product in the patent listed differs from ours in that it relies on blockchain technology to complete transactions using cryptocurrency.

US patent application 2017/0048234 discloses a fractionally efficient transfer guidance apparatus and method of use. The present invention is distinguished from '234 because it doesn't use fractionally efficient transfer guidance.

US patent application 2017/0048235 discloses a crypto captcha data structure apparatus and system. The product in the patent listed differs from ours in that it relies on blockchain technology to complete transactions using cryptocurrency and unique wallets for identification.

US patent application 2017/0083907 discloses a point-to-point transaction guidance apparatus and method. The present invention is distinguished from '907 because it does not do point-to-point.

US patent application 2017/0085555 discloses a point-to-point transaction guidance apparatus and method. The product in the patent listed differs from ours in that it relies on blockchain technology to complete transactions using cryptocurrency and unique wallets for identification.

US patent application 2017/0109735 discloses a transfer processing and auditing apparatus, method and system. The product in the patent listed differs from ours in that it relies on blockchain technology to complete transactions using cryptocurrency and unique wallets for identification.

US patent application 2017/0187535 discloses devices, systems and methods for facilitating low trust and zero trust value transfers. The product in the patent listed differs from ours in that it requires a third party to facilitate in the conditions of provided loans. We allow users to create loans with their own conditions in mind given certain conditions. The product in the patent listed also relies on blockchain technology to create transactions.

US patent application 2017/0221052 discloses a transfer processing and auditing apparatus, method and system. The product in the patent listed differs from the present invention in that it relies on a blockchain to perform transactions.

US patent application 2019/0058604 discloses systems and methods for storing and sharing transactional data using a computing system. The product in the patent listed differs from the present invention in that it is centralized around a blockchain as a huge part of the operation.

### SUMMARY

In some embodiments of the present invention, the present invention is an improved information maintenance and processing device and method of use.

In several embodiments of the present invention, upon launching present application for the first time, a user creates a profile with necessary info such as email, full name, password, etc. Once the user successfully creates a profile, the user is directed to a page that gives them two options. The first option is to sign in as a lender, and the other option is to sign in as a receiver.

In several embodiments of the present invention, if signed in as a lender, the user will be able to explore all loan requests and can select a request to lend and fulfill the requester's offer. Also, while signed in as a lender, the user can offer a friendly loan to friends and family where the interest rate is very minimal. A lender can also track the current loans in progress and can also check the history of completed loans.

In several embodiments of the present invention, if signed in as a receiver, the user will be able to request a loan and sets the amount and the interest rate that he would owe to the lender. Receivers can also track their requested loan and its progress.

In several embodiments of the present invention, a loan can range from $100 to $500. In several embodiments of the present invention, a loan can stay in the explore page for a time period of forty-eight hours. In several embodiments, a loan can have an interest rate of 10% if returned in two weeks or less, 15% if the return date is after two weeks, and a fixed 20% if the return date is more than a month. In several embodiments, if no lender is looking to accept a requested loan within forty-eight hours, the receiver has the option to lend from the parent company at 25%.

In several embodiments, on the first strike (or negative mark on a user's credit), the users credit will be affected. In several embodiments, on the second strike, the user's credit will be affected, and the user's account will be put on freeze. In several embodiments, on the third strike, the user's credit will be affected, and the user's account will be disabled for 6 months. In several embodiments, a lender can withdraw the owed amount from the bank of the borrower regardless of borrower balance. In several embodiments, the hosting company can disable and remove a profile from the inventive platform from a borrower and the user will have to reapply after a six month suspension period in order to be allowed back on the inventive platform.

In several embodiments, if after the three strikes the user decides to use our platform again after six months of disabling his/her account and repeats the same cycle of three strikes, the user's account will be disabled for an entire year (twelve months).

In several embodiments, the present invention provides unique improvements in anonymity and privacy; smaller loans ($100-$500); and lower max interest rate (20% from lenders, 25% is offered from the parent company).

In several embodiments, the invention claimed is: A computer system configured to store user information and user requests comprising: a first computer with a transceiver and a receiver; a second computer with a transceiver and a receiver; said first computer transceiver is configured to communicate with said second computer receiver; said second computer system communicates data packets to said first computer; a storage system to hold user information; said information held in said storage system includes bank information, social security numbers, unique identifiers, current requested loans, current accepted loans, and past loan information; and a computer processing system that includes at least one hardware processor with a transmitter and a receiver configured to receive, match data, and generate a unique code that a user will be able to input into a smart device to create a loan; said computer processing system further comprising: a network; a network interface which transmits information to a database, external resources, or to said network; a system bus; said network interface receives or transmits information to said system bus; RAM; said RAM receives or transmits information to said system bus; a processing system; said processing system comprises at least four central processing units; said processing system receives or transmits information to said system bus; and a user device that receives or transmits information to said network.

In several embodiments, the invention claimed is: A computer processing system comprising: a network; a network interface which transmits information to a database, external resources, or to said network; a system bus; said network interface receives or transmits information to said system bus; RAM; said RAM receives or transmits information to said system bus; a processing system; said processing system comprises at least four central processing units; said processing system receives or transmits information to said system bus; and a user device that receives or transmits information to said network.

### BRIEF DESCRIPTION OF THE DRAWINGS

For a more complete understanding of the present disclosure and the advantages thereof, reference is now made to the following descriptions to be taken in conjunction with the accompanying drawings describing specific embodiments of the disclosure, wherein:

FIG. 1 illustrates one embodiment of logic flow chart of the present invention.

FIG. 2 illustrates one embodiment of the logic flow chart of the present invention.

FIG. 3 illustrates one embodiment of the logic flow chart of the present invention.

FIG. 4 is a relationships diagram of one embodiment of the present invention.

FIG. 5 is an administrator's diagram of one embodiment of the present invention.

FIG. 6 is a receiver diagram of one embodiment of the present invention.

FIG. 7 is a processing diagram of one embodiment of the present invention.

FIG. 8 is a lender diagram of one embodiment of the present invention.

FIG. 9 is a small business diagram of one embodiment of the present invention.

### DETAILED DESCRIPTION

One or more illustrative embodiments incorporating the invention disclosed herein are presented below. Applicant has created a revolutionary and improved peer to peer information maintenance and processing device and method of use.

In the following description, certain details are set forth such as specific quantities, sizes, etc. to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing embodiments of the disclosure and are not intended to be limiting thereto. Drawings are not necessarily to scale, and arrangements of specific units in the drawings can vary.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless, or essentially meaningless, the definition should be taken from Webster's Dictionary 2020, 11^{th} Edition. Definitions and/or interpretations should not be incorporated from other patent applications, patents, or publications, related or not, unless specifically stated in this specification, or if the incorporation is necessary for maintaining validity. As utilized herein, the following terms have the following definitions.

In several embodiments of the present invention, “Lender” means “Investor/LyndrX, or the person/company giving the money or loan”.

In several embodiments of the present invention, “Borrower” means “the requestor, or the person/company who is asking for money”.

In several embodiments of the present invention, “Receiver” means “the person/company getting/receiving funding”.

In several embodiments of the present invention, “Computer Receiver” means “the element of a computer that can receive data”.

In several embodiments of the present invention, “Strike” means “a negative hit on a person/company profile or credit history”.

In several embodiments of the present invention, “LoanRequest” means “the money a person/company is asking for”.

In several embodiments of the present invention, “DB” means “a data base”.

In several embodiments of the present invention, “Login Buttons” means “that is the user interface used to log into your account”.

In several embodiments of the present invention, “Network Interface” means “the adapter that plugs into the network like Wi-Fi, it connects a person/company to the internet”.

In several embodiments of the present invention, “Login Page” means “the person/company login credential to access a profile”.

In several embodiments of the present invention, “RAM” means “short term memory storage”.

In several embodiments of the present invention, “CPU Unit” means “computer processing unit”.

In several embodiments of the present invention, “System Bus” means “a device that connects major components of a computer system”.

In several embodiments of the present invention, “Buttons” can mean a “user interface”.

In several embodiments of the present invention, “Small Business” can mean any business with a gross revenue of under one million dollars per year.

While preferred embodiments have been shown, and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied.

In several embodiments, one embodiment of the present invention works as follows: In several embodiments, upon launching the present invention for the first time, a user creates a profile with necessary info such as email, full name, password, etc. Once the user successfully creates a profile, the user is directed to a page that gives them two options. The first option is to sign in as a lender, and the other option is to sign in as a receiver.

In several embodiments, if signed in as a lender, the user will be able to explore all loan requests and can select a request to lend and fulfill the requester's offer. Also, while signed in as a lender, the user can offer a friendly loan to friends and family where the interest rate is very minimal. A lender can also track the current loans in progress and can also check the history of completed loans.

In several embodiments, if signed in as a receiver, the user will be able to request a loan and can set the amount and the interest rate that he would owe to the lender. Receivers can also track their requested loan and its progress.

In several embodiments, a loan can range from $100 to $500. In several embodiments, a loan can stay in the explore page for a time period of forty-eight hours. In several embodiments, a loan has an interest rate of 10% if returned within two weeks, 15% if the return date is after two weeks, and a fixed 20% if the return date is more than a month. In several embodiments, if no lender is looking to accept a requested loan within forty-eight hours, the receiver has the option to lend from us (the parent company) at 25%. In several embodiments, on the first strike, the user's credit will be affected, which can mean that the hosting company can report negative information to credit bureaus. In several embodiments, on the second strike, the user's credit will be affected, and the user's account will be put on freeze status. In several embodiments, on the third strike, the user's credit will be affected, and the user's account will be disabled for six months.

In several embodiments, if after the three strikes the user decides to use our platform again after 6 months of disabling his/her account and repeats the same cycle of three strikes, the user's account will be disabled for an entire year (twelve months).

In several embodiments, the present embodiment provides unique improvements in anonymity and privacy; smaller loans ($100-$500); and lower max interest rate (20% from lenders, 25% is offered from the parent company).

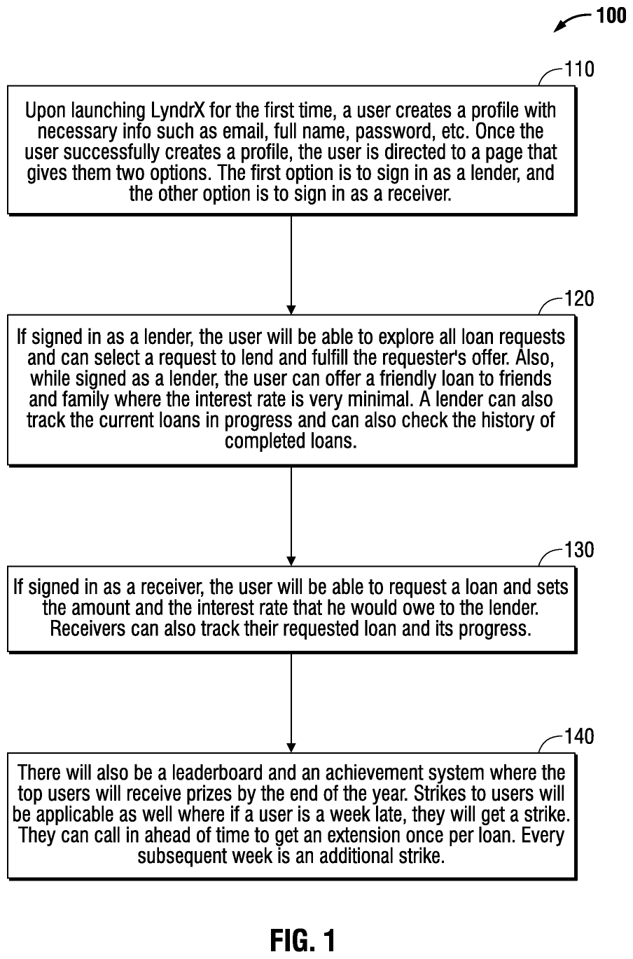

FIG. 1 illustrates one embodiment of logic flow chart of the present invention. In several embodiments of the present invention, upon launching the present invention for the first time, a user creates a profile with necessary information such as e-mail, full name, password, and other standard data inputs. Once the user has created the profile, the user is directed to a page that gives them two options: sign in as a lender, or sign in as a receiver 110.

In several embodiments, if signed in as a lender, the user will be able to explore all loan requests for a receiver and can select a request to lend and fulfill for a receiver's offer. In several embodiments, while signed in as a lender, the user can offer a friendly loan to other friends or family at a reduced interest rate. In several embodiments, a lender can track current loans in progress and can also check the history of completed loans 120.

In several embodiments, if a user is signed in as a receiver, the user will be able to request a loan and can set the amount and the interest rate that they would owe to the lender. Receivers can also track their requested loan and its progress 130.

In several embodiments, there can be a leaderboard and an achievement system where the top users will receive prizes by the end of the set fiscal period, or year. In several embodiments, strikes to users will be applicable as well, where a user is late in a set task, such as a payment. In several embodiments, a user can notify a lender to get an extension to pay on a loan or pay a late payment 140.

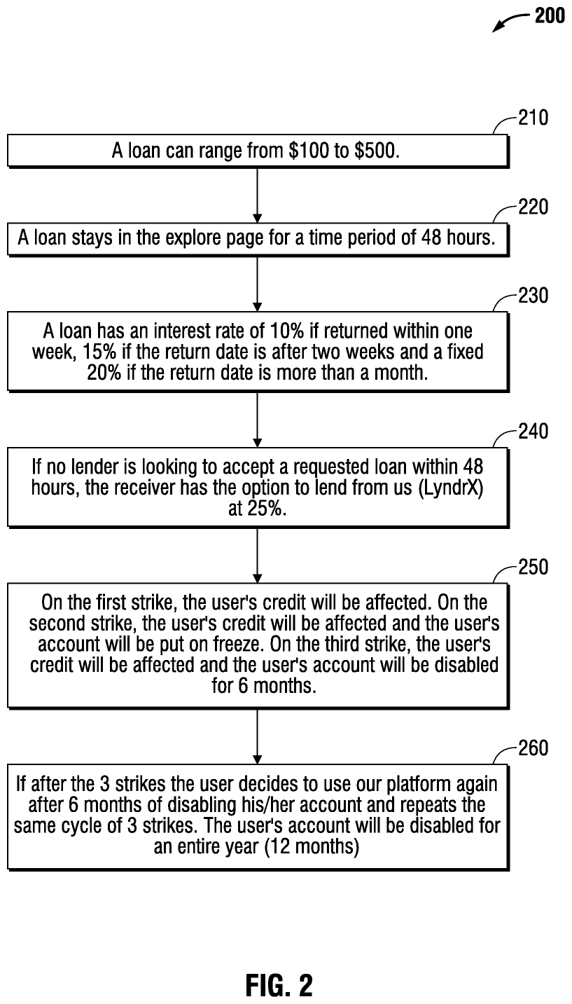

FIG. 2 illustrates one embodiment of the logic flow chart of the present invention. In several embodiments of the present invention, a loan can range from $100 to $500 210. In several embodiments, a loan can stay in the explore page for a time period of 48 hours 220. In several embodiments of the present invention, a loan can have an interest rate of 10% if returned within one week, 15% if the return date is after two weeks, and a fixed 20% if the return date is more than a month 230.

In several embodiments, if no lender is looking to accept a requested loan with forty-eight hours, the receiver has the option to lend from a preestablished lender (the parent company) at 25% 240. In some embodiments, on the first strike, the user's credit will be affected. In some embodiments, on the second strike, the user's credit will be affected, and the user's account will be put on freeze status. In some embodiments, on the third strike, the user's credit will be affected, and the user's account will be disabled for 6 months 250.

In several embodiments, if after the three strikes the user decides to use our platform again after six months of disabling his/her account and repeats the same cycle of three strikes, then the user's account can be disabled for an entire year (12 months) 260.

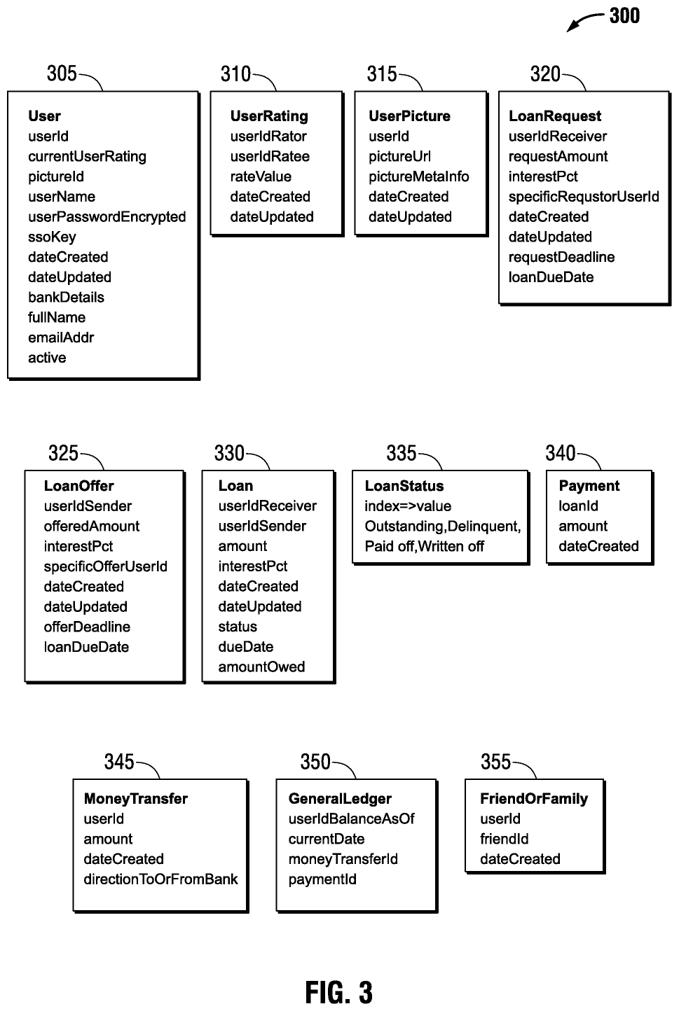

FIG. 3 illustrates one embodiment of the definition page 300 of the present invention. In several embodiments of the present invention, the user information 305 can comprise: userId, currentUserRating, pictureId, userName, UserPasswordEncrypted, ssoKey, dateCreated, dateUpdated, bankDetails, fullName, emailAddr, and/or active (as are all used in the art).

In several embodiments of the present invention, the UserRating 310 can comprise: userIdRator, userIdRatee, rateValue, dateCreated, and/or dateUpdated. In several embodiments, of the present invention the UserPicture 315 can comprise: userId, pictureUrl, pictureMetalnfo, dateCreated, and/or dateUpdated (as are all used in the art).

In several embodiments of the present invention, LoanRequest 320 can comprise: userIdReceiver, requestAmount, interestPct, specificRequestorUserld, dateCreated, dateUpdated, requestDeadline, and/or loanDueDate. In several embodiments of the present invention, LoanOffer 325 can comprise: userIdSender, offeredAmount, interestPct, specificOfferUserld, dateCreated, dateUpdated, offerDeadline, and/or loanDueDate (as are all used in the art). In several embodiments of the present invention, Loan 330 can comprise: userIdReciever, userIdSender, amount, interestPCT, dateCreated, dateUpdated, status, dueDate, and/or amountOwed (as are all used in the art). In several embodiments of the present invention, LoanStatus 335 can comprise: index=>value, Outstanding, Delinquent, Paid off, and/or Written off (as are all used in the art).

In several embodiments of the present invention, Payment 340 can comprise: loanld, amount, and/or dateCreated. In several embodiments of the present invention, MoneyTransfer 345 can comprise: userId, amount, dateCreated, and/or directionToOrFromBank (as are used in the art). In several embodiments of the present invention, GeneralLedger can comprise: userIdBalanceAsOf, currentDate, moneyTransferld, and/or paymentId (as are used in the art). In several embodiments of the present invention, FriendOrFamily can comprise: userId, friendld, and/or dateCreated (as are used in the art).

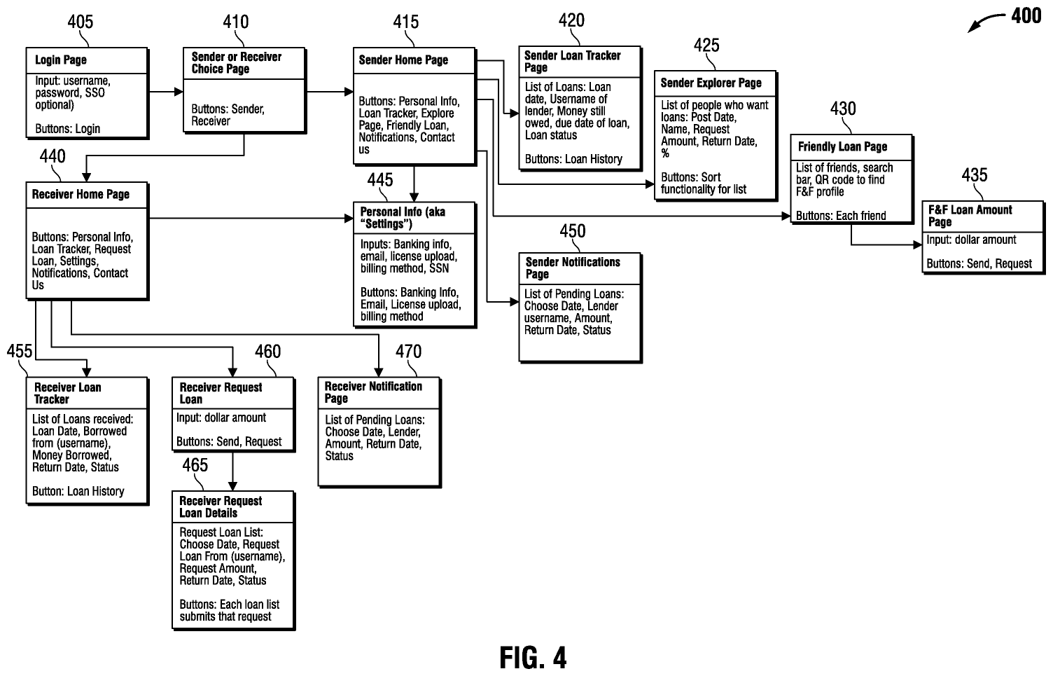

FIG. 4 is a relationships diagram of one embodiment of the present invention. In several embodiments of the present invention, the relationship logic diagram 400 flows as follows. In several embodiments of the present invention, a login page 405 is constructed to have input such as a username, password, and optional SSO. There are also login buttons.

In several embodiments of the present invention, after the information on the login page 405 is entered the information is sent to the Sender or Receiver Choice Page 410, which can have Sender and/or Receiver buttons. After this information is received, it is sent to the Sender Home Page 415 or the Receiver Home Page 440.

In several embodiments of the present invention, if the information is sent to the Sender Home Page 415, the Sender Home Page 415 can have buttons such as: Personal Info, Loan Tracker, Explore Page, Friendly Loan, Notifications, and/or Contact us. Information from the Sender Home Page 415 can be sent to the Sender Loan Tracker Page 420, Sender Explorer Page 425, Friendly Loan Page 430, Sender Notifications Page 450, and/or Personal Information (aka “Settings”) Page 445.

In several embodiments of the present invention, the Sender Loan Tracker Page 420 can include a list of loans with information such as: Username of the lender, Money still owed, due date of loan, and/or loan status. In several embodiments this can include buttons for Loan History.

In several embodiments of the present invention, the Sender Explorer Page 425 can include: a List of people who want loans, Post Date, Name, Request Amount, Return Date, and Percentages. Several buttons can include loan history, current loans and total profits earned.

In several embodiments of the present invention, the Friendly Loan Page 430 can include: a list of friends, search bar and/or QR code to find F&F profile. Some buttons can include “each friend”.

In several embodiments of the present invention, the F&F Loan Amount Page 435 can include input of dollar amount and buttons such as send and request.

In several embodiments of the present invention, the Sender Notifications Page 450 can include: List of Pending Loans which can include: Choose Date, Lender username, Amount, Return Date, and/or Status.

In several embodiments of the present invention, the Personal Information 445 (aka “Settings”) can include: Inputs such as: banking info, email, license upload, and/or billing method.

Buttons can include: banking information, email, license upload, Social Security number, and billing method.

In several embodiments of the present invention, the Receiver Home Page 440 can include buttons such as: Personal Information, Loan Tracker, Request Loan, Settings, Notifications, and/or Contact Us. In several embodiments of the present invention, information from the Receiver Home Page 440 can be sent to the Personal Information Page 445, Receiver Loan Tracker Page 455, Receiver Request Loan Page 460 and/or the Receiver Notification Page 470.

In several embodiments of the present invention, Receiver Loan Tracker Page 455 has information such as a List of Loans received, Loan Dates, Borrowed from (username), Money Borrowed, Return Date, and/or Status. Some buttons may include a loan history.

In several embodiments of the present invention, the Receiver Request Loan Page 460 can include: an input of dollar amount and buttons such as send and request. Information from the Receiver Request Loan Page 460 can be sent to the Receiver Request Loan Details Page 465. Information on the Receiver Request Loan Details Page 465 can include a Request Loan List. The Request Loan List can include: a Choose Date, Request Loan From (username), Request Amount, Return Date, and/or Status. Buttons can provide information on each loan list submitted that is requested.

In several embodiments of the present invention, the Receiver Notification Page 470 can include a List of Pending Loans. The List of Pending Loans can include information such as: Chosen Date, Lender, Amount, Return Date, and/or Status.

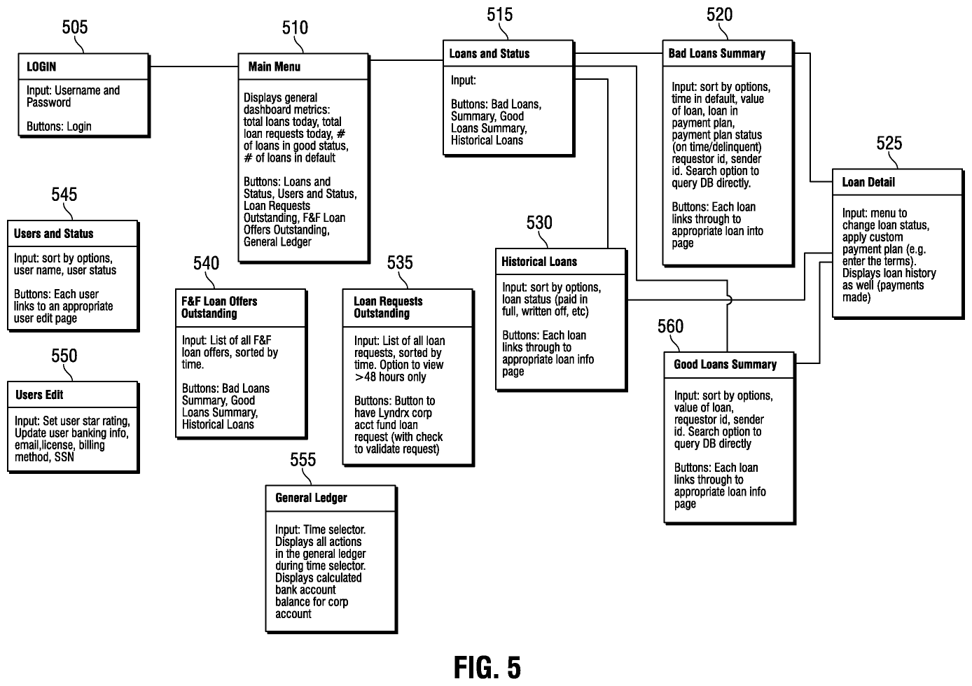

FIG. 5 is an administrator's map of one embodiment of the present invention. As shown is one embodiment of the administrators map 500 the present invention. In several embodiments of the present invention, there is Login page 505. In several embodiments of the present invention, Login Page 505 has an Input with Username and Password. Several embodiments can include a Login button.

In several embodiments of the present invention, there is a Main Menu Page 510 which can include display general dashboard metrics with: total loans today, total loans requested today, number of loans in good status, and number of loans in default. On this page buttons can include: Loans and Status, Users and Status, Loan Requests Outstanding, Friends and Family LoanOoffers Outstanding, and General Ledger. The present invention is an improvement over prior art in that it improves speed and accuracy of processing data, thereby getting a request granted.

In several embodiments of the present invention, there is a Loans and Status Page 515. In several embodiments, buttons on this page can include: Bad Loans Summary, Good Loans Summary, and Historical Loans. In several embodiments, from the Loans and Status page 515 information can be routed to the Bad Loans Summary Page 520, Good Loans Summary Page 560 and/or the Historical Loans Page 530.

In several embodiments of the present invention, the Bad Loans Summary Page 520 can include input such as: sort by options, time in default, value of loan, loan in payment plan, payment plan status (on time/delinquent), requestor id, sender id, and/or search option to query DB directly. In several embodiments, buttons can include each loan link through to appropriate loan info page. In several embodiments of the present invention, information from the Bad Loans Summary 520 can be sent to the Loan Detail Page 525.

In several embodiments of the present invention, Loan Detail Page 525 incudes input such as menu to change loan status, apply custom payment and/or display loan history. In several embodiments of the present invention, the Loan Detail Page 525 can send information to the Good Loans Summary Page 560 and/or Historical Loans 530. This organizational method and apparatus makes it easier for requests to be approved or denied at an expedited rate.

In several embodiments of the present invention, Good Loans Summary Page 560 can include information input such as: sort by options, value of loan, requestor id, sender id, and/or search options to query DB directly. In several embodiments, buttons can include each loan link through to appropriate loan information page.

In several embodiments of the present invention, Historical Loans Page can include input such as: sort by options and/or loan status (paid in full, written off, etc.). In several embodiments, buttons can include each loan link through to appropriate loan information page.

In several embodiments of the present invention, there can be a Loan Requests Outstanding Page 535 which can have input such as: lists of all loan requests, time sorting and/or the option to view items of less than a certain time frame. Buttons can include a button to have a corporation account to fund a loan request.

In several embodiments of the present invention, there can include a F&F (“F&F can be defined as Friends and Family”) Loan Offers Outstanding Page 540 which can include input such as listing all F&F loan offers and time sorting capabilities. Buttons can include Bad Loans Summary, Good Loans Summary, and Historical Loans.

In several embodiments of the present invention, there can include a Users and Status Page 545 which can include input such as sort by options, user name, and user status. Buttons can allow for a user to link to an appropriate user edit page.

In several embodiments of the present invention, there can include a User Edit Page 550 with input such as: Set user star rating, Update user banking information, email, license, and/or billing methods.

In several embodiments of the present invention, there can include a General Ledger Page 555 which can include input such as: time selection (which displays all actions in the general ledger during a selected time), and/or a display of a calculated bank account balance for a corporate account.

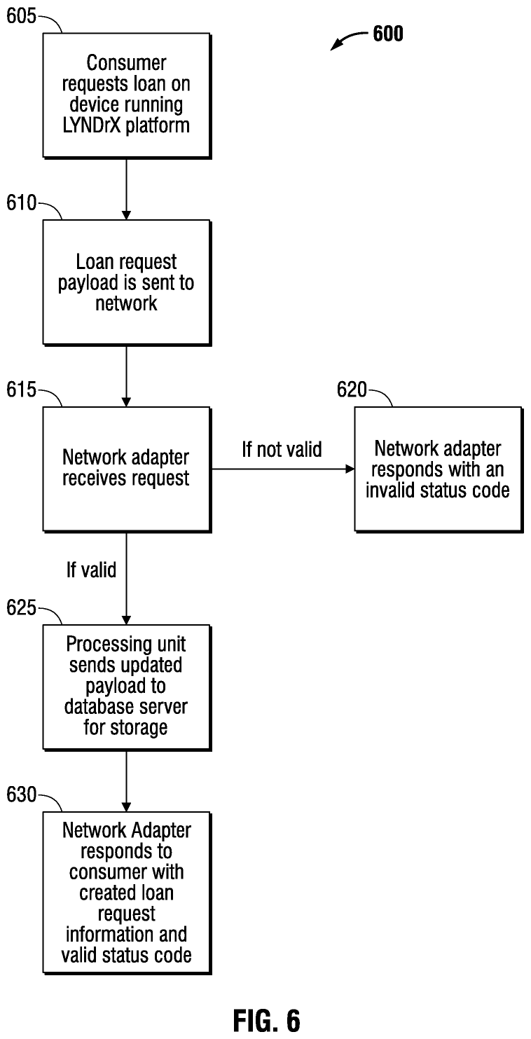

FIG. 6 is a receiver diagram of one embodiment of the present invention. As shown is receiver flow chart 600 as found in one embodiment of the present invention. In some embodiments of the present invention, a consumer can request a loan on a device running the present inventive platform 605. In some embodiments of the present invention, the loan request in then sent to a network 610. In some embodiments of the present invention, the network adapter receives the request 615. In some embodiments of the present invention, if the request is not valid then the network adapter responds with an invalid status code 620.

In some embodiments of the present invention, if the request is valid then a processing unit sends updated payload to a database server for storage 625. In some embodiments of the present invention, the network adapter can then respond to a consumer with created loan request information and a valid status code.

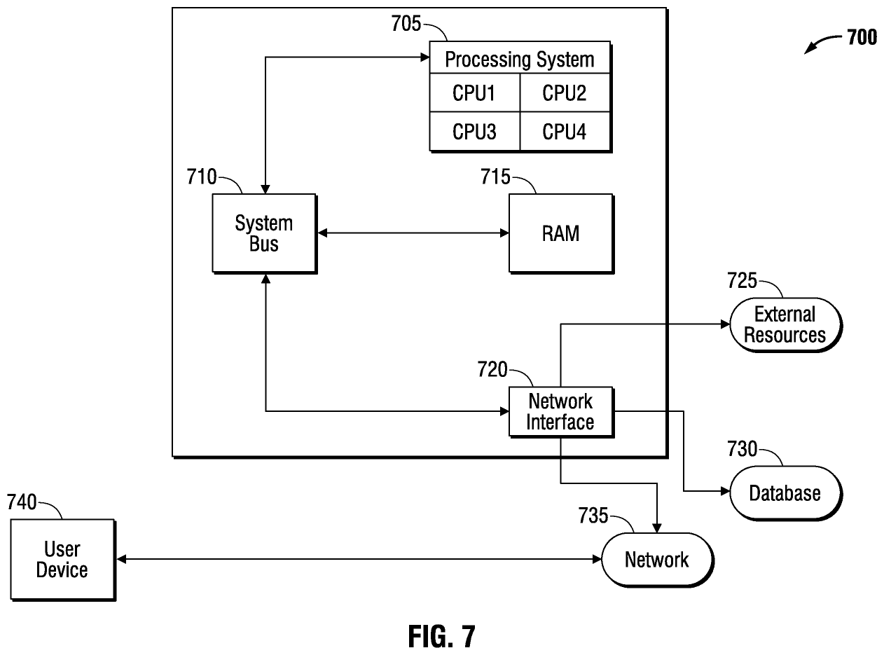

FIG. 7 is a processing diagram of one embodiment of the present invention. In some embodiments of the present invention, as shown, is a process flow diagram 700. In some embodiments of the present invention, as shown, a user device 740 can receive or transmit information to a network 735. In some embodiments of the present invention, the network 735 can receive information from a network interface 720. In some embodiments of the present invention, the network interface 720 can transmit information to a database 730 or external resources 725.

In some embodiments of the present invention, the network interface 720 can send and receive signals from a system bus 710. In some embodiments of the present invention, the system bus 710 can send and receive information to a RAM 715. In some embodiments of the present invention, the system bus 710 can send and receive information from a processing system 705. In several embodiments of the present invention, the processing system 705 can comprise at least four CPU units. The four CPU unit system can be utilized to expedite information processing by running variant information pieces through multiple processing systems.

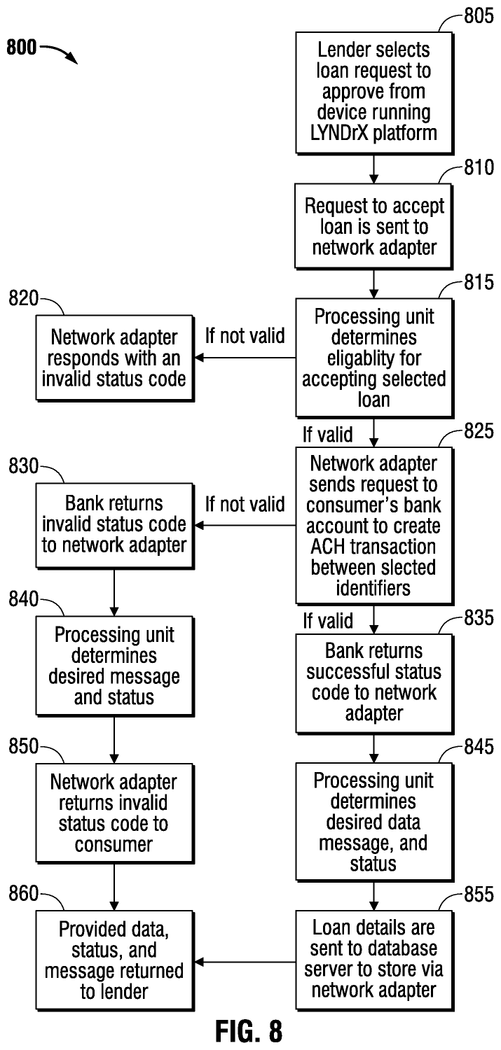

FIG. 8 is a lender diagram of one embodiment of the present invention. In several embodiments of the present invention, as shown, is a lender flow diagram 800. In several embodiments of the present invention, a lender can select a loan request to approve from a device running the present inventive program 805. In several embodiments of the present invention, the request to accept a loan is then sent to a network adapter 810. In several embodiments of the present invention, a processing unit determines eligibility for accepting selected loan 815. In several embodiments of the present invention, if the request is not valid, then a network adapter responds with an invalid status code 820.

In several embodiments of the present invention, if the request is valid, then the network adapter sends a request to a consumer's bank account to create an ACH, or automated clearing house, transaction between selected identifiers 825. In several embodiments of the present invention, if this request is not valid, then the bank returns an invalid status code to a network adapter 830. In several embodiments of the present invention, a processing unit then can determine a desired message and status 840. In several embodiments of the present invention, a network adapter can then return an invalid status code to a consumer 850. In several embodiments of the present invention, a processing unit then can determine a desired message, data and status to be returned to the lender 860. In several embodiments of the present invention, if the request to a consumer's bank account to create an ACH, or automated clearing house, transaction between selected identifiers 825 is valid, then the consumer's bank returns a successful status code to a network adapter 835. In several embodiments of the present invention, a processing unit then can determine a desired data message and status 845. In several embodiments of the present invention, the loan details are then sent to a database server to be stored through a network adapter 855. In several embodiments of the present invention, a processing unit then can determine a desired message, data and status to be returned to the lender 860.

In several embodiments of the present invention, if the request is valid then the network adapter sends a request to a consumer's bank account to create an ACH transaction between selected identifiers 825, if the request is valid then a bank can return a successful status code to a network adapter 835. In several embodiments of the present invention, a processing unit can then determine a desired message and status 845. In several embodiments of the present invention, loan details are then sent to a database server to store via a network adaptcr 855. In several embodiments, provided data, status and a message is then returned to the lender 860.

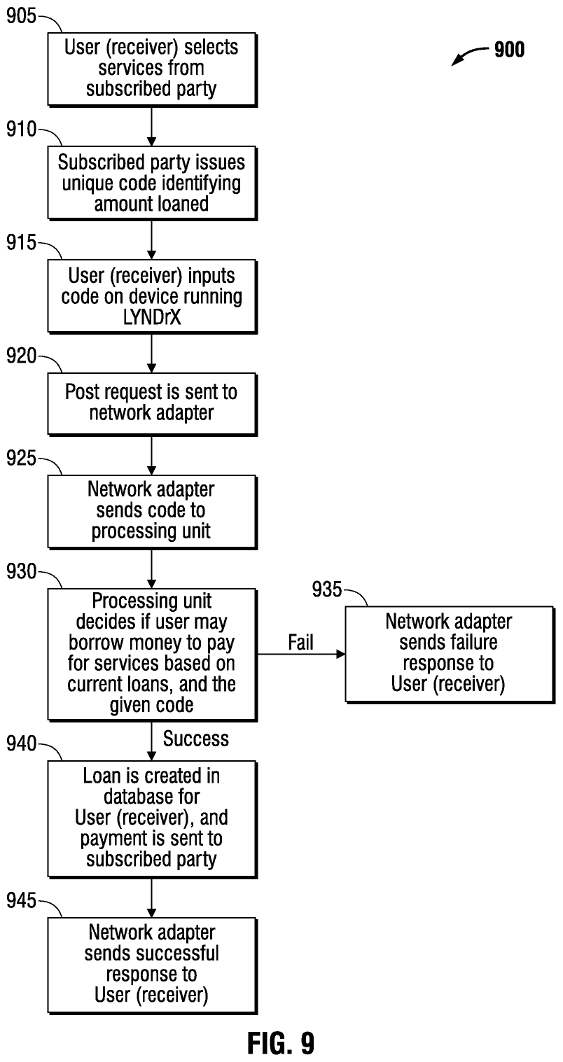

FIG. 9 is a small business loan diagram of one embodiment of the present invention. As shown is receiver flow chart 900 as found in one embodiment of the present invention. In some embodiments of the present invention, a user/receiver, in many cases a small business, can select services from a lender or subscribed party 905. In some embodiments of the present invention, the subscribed party can then issue a unique code identifying an amount loaned 910. In some embodiments of the present invention, the user can then input a code on a device running the present inventive program 915.

In some embodiments of the present invention, a post request is sent to a network adapter 920. In some embodiments of the present invention, a network adapter sends code to a processing unit 925. In some embodiments of the present invention, a processing unit then decides if user may borrow money to pay for services based on current loans, and the given code 930. In some embodiments of the present invention, if the processing unit decides that the user may not borrow money, or a failure, then the network adapter sends failures response to User (receiver) 935.

In some embodiments of the present invention, if the processing unit reviews that the user may borrow money, or a success, then the loan is created in a database for the User (receiver) and a payment is sent to a subscribed party 940. In some embodiments, the network adapter can then send a successful response to a User (receiver) 945.

In several embodiments of the present invention, if the request is valid then the network adapter sends a request to a consumer's bank account to create an ACH transaction between selected identifiers 825, if the request is valid then a bank can return a successful status code to a network adapter 835. In several embodiments of the present invention, a processing unit can then determine a desired message and status 845. In several embodiments of the present invention, loan details are then sent to a database server to store via a network adapter 855. In several embodiments, provided data, status and a message is then returned to the lender 860.

In several embodiments, the invention claimed is: A computer system that is configured to store user information and user requests/current loans, the computer system comprising: A transceiver configured to communicate with at least another computer system that communicates available loan requests and requests to create loans, a storage system to hold user information, which could include bank information, social security numbers and other unique identifiers, as well as information on current requested loans, current accepted loans, and past loan information, a processing system that includes at least one hardware processor configured to: receive, via the transceiver, match data between two consumers that would like to create a loan, Based on the match data received: Generate a payload which includes received loan information that will be stored in the storage device to represent a created loan. Generate a unique code that a consumer will be able to input into their smart device to create a loan.

In several embodiments, the present invention is a computer system configured to store user information and user requests comprising: a first computer with a transceiver and a computer receiver; a second computer with a transceiver and a computer receiver; said first computer transceiver is configured to communicate with said second computer receiver; said second computer system communicates data packets to said first computer; a storage system to hold user information; said information held in said storage system includes bank information, social security numbers, unique identifiers, current requested loans, current accepted loans, and past loan information; and a computer processing system that includes at least one hardware processor with a transmitter and a computer receiver configured to receive, match data, and generate a unique code that a user will be able to input into a smart device to create a loan; said computer processing system further comprising; a network; a network interface which transmits information to a database, external resources, or to said network; a system bus; said network interface receives or transmits information to said system bus; RAM; said RAM receives or transmits information to said system bus; a processing system; said processing system comprises at least four central processing units; said processing system receives or transmits information to said system bus; and a user device that receives or transmits information to said network. In some embodiments, said first computer is a cell phone, smart device, laptop or tabletop unit. In some embodiments, said second computer is a cell phone, smart device, laptop or tabletop unit. In some embodiments, said unique identifier is a state issued ID, license, passport, or government ID. In some embodiments, said user device is a cell phone, smart device, laptop or tabletop unit. In some embodiments, said processing system comprises at least four central processing units. In some embodiments, said network further comprises a network adapter.

In some embodiments, the invention is a computer processing system comprising: a network; a network interface which transmits information to a database, external resources, or to said network; a system bus; said network interface receives or transmits information to said system bus; RAM; said RAM receives or transmits information to said system bus; a processing system; said processing system comprises at least four central processing units; said processing system receives or transmits information to said system bus; and a user device that receives or transmits information to said network. In some embodiments, said user device is a cell phone, smart device, laptop or tabletop unit. In some embodiments, said processing system comprises at least four central processing units. In some embodiments, said network further comprises a network adapter.

In several embodiments, the present invention is a computer system configured to store user information and user requests comprising: a lender; a receiver; a borrower; a first computer with a transceiver and a computer receiver; a second computer with a transceiver and a computer receiver, said first computer transceiver is configured to communicate with said second computer receiver; said second computer system communicates data packets to said first computer; a storage system to hold user information; said information held in said storage system includes bank information, social security numbers, unique identifiers, current requested loans, current accepted loans, and past loan information; and a computer processing system that includes at least one hardware processor with a transmitter and a computer receiver configured to receive, match data, and generate a unique code that a user will be able to input into a smart device to create a loan; said computer processing system further comprising; a network; a network interface which transmits information to a database, external resources, or to said network; a system bus; said network interface receives or transmits information to said system bus; RAM; said RAM receives or transmits information to said system bus; a processing system; said processing system comprises at least four central processing units; said processing system receives or transmits information to said system bus; and a user device that receives or transmits information to said network; wherein said lender can receive and transmit information to said first computer, said receiver can receive and transmit information to said second computer; and said borrower can receive and transmit information to said first computer. In several embodiments, said first computer is a cell phone, smart device, laptop or tabletop unit. In several embodiments, said second computer is a cell phone, smart device, laptop or tabletop unit. In several embodiments, said unique identifier is a state issued ID, license, passport, or government ID. In several embodiments, said user device is a cell phone, smart device, laptop or tabletop unit. In several embodiments, said processing system comprises at least four central processing units. In several embodiments, said network further comprises a network adapter.

While preferred embodiments have been shown and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied. Accordingly, it is intended that the following claims be interpreted to embrace all such variations and modifications.

What is claimed is the following:

1. A computer system configured to store user information and user requests comprising:
a first computer with a transceiver and a computer receiver;
a second computer with a transceiver and a computer receiver;
said first computer transceiver is configured to communicate with said second computer receiver,
said second computer system communicates data packets to said first computer;
a storage system to hold user information;
said information held in said storage system includes bank information, social security numbers, unique identifiers, current requested loans, current accepted loans, and past loan information; and
a computer processing system that includes at least one hardware processor with a transmitter and a computer receiver configured to receive, match data, and generate a unique code that a user will be able to input into a smart device to create a loan;
said computer processing system further comprising;
a network;
a network interface which transmits information to a database, external resources, or to said network;
a system bus;
said network interface receives or transmits information to said system bus;
RAM;
said RAM receives or transmits information to said system bus;
a processing system;
said processing system comprises at least four central processing units;
said processing system receives or transmits information to said system bus; and
a user device that receives or transmits information to said network.

2. The computer system of claim 1 further comprising:
said first computer is a cell phone, smart device, laptop or tabletop unit.

3. The computer system of claim 1 further comprising:
said second computer is a cell phone, smart device, laptop or tabletop unit.

4. The computer system of claim 1 further comprising:
said unique identifier is a state issued id, license, passport, or government ID.

5. The computer system of claim 1 further comprising:
said user device is a cell phone, smart device, laptop or tabletop unit.

6. The computer system of claim 1 further comprising:
said processing system comprises at least four central processing units utilized to expedite information processing by running variant information pieces through multiple systems.

7. The computer system of claim 1 further comprising:
said network further comprises a network adapter.

8. A computer processing system comprising:
a network;
a network interface which transmits information to a database, external resources, or to said network;
a system bus;
said network interface receives or transmits information to said system bus;
RAM;
said RAM receives or transmits information to said system bus;
a processing system;
said processing system comprises at least four central processing units;
said processing system receives or transmits information to said system bus; and
a user device that receives or transmits information to said network.

9. The computer system of claim 8 further comprising:
said user device is a cell phone, smart device, laptop or tabletop unit.

10. The computer system of claim 9 further comprising:
said processing system comprises at least four central processing units utilized to expedite information processing by running variant information pieces through multiple processing systems.

11. The computer system of claim 9 further comprising:
said network further comprises a network adapter.

12. A computer system configured to store user information and user requests comprising:
a lender,
a receiver;
a borrower;
a first computer with a transceiver and a computer receiver;
a second computer with a transceiver and a computer receiver;
said first computer transceiver is configured to communicate with said second computer receiver;
said second computer system communicates data packets to said first computer;
a storage system to hold user information;
said information held in said storage system includes bank information, social security numbers, unique identifiers, current requested loans, current accepted loans, and past loan information; and
a computer processing system that includes at least one hardware processor with a transmitter and a computer receiver configured to receive, match data, and generate a unique code that a user will be able to input into a smart device to create a loan;
said computer processing system further comprising;
a network;
a network interface which transmits information to a database, external resources, or to said network;
a system bus;
said network interface receives or transmits information to said system bus;
RAM;
said RAM receives or transmits information to said system bus;
a processing system;
said processing system comprises at least four central processing units;
said processing system receives or transmits information to said system bus; and
a user device that receives or transmits information to said network; wherein
said lender can receive and transmit information to said first computer;
said receiver can receive and transmit information to said second computer; and
said borrower can receive and transmit information to said first computer.

13. The computer system of claim 12 further comprising:
said first computer is a cell phone, smart device, laptop or tabletop unit.

14. The computer system of claim 12 further comprising:
said second computer is a cell phone, smart device, laptop or tabletop unit.

15. The computer system of claim 12 further comprising:
said unique identifier is a state issued id, license, passport, or government ID.

16. The computer system of claim 12 further comprising:
said user device is a cell phone, smart device, laptop or tabletop unit.

17. The computer system of claim 12 further comprising:
said processing system comprises at least four central processing units utilized to expedite information processing by running variant information pieces through multiple processing systems.

18. The computer system of claim 12 further comprising:
said network further comprises a network adapter.

19. The computer system of claim 12 further comprising:
said receiver can be a small business or an individual.
